(19) United States
(12) Patent Application Publication
(10) Pub. No.: US 2018/0086856 A1
(43) Pub. Date: Mar. 29, 2018

(54) Method and apparatus for the preparation of a polyolefin

(71) Applicant: Linde Aktiengesellschaft, München (DE)

(72) Inventors: Andreas MEISWINKEL, Prien (DE); Helmut FRITZ, München (DE); Hans-Jörg ZANDER, München (DE); Anton KIRZINGER, München (DE); Josef FREISINGER, Pullach (DE); Can ULUBAY, Penzberg (DE); Walter HESCH, Geretsried (DE); Thomas WINKLER, Pullach (DE); Anina WÖHL, München (DE)

(21) Appl. No.: 15/566,157

(22) PCT Filed: Apr. 13, 2016
(86) PCT No.: PCT/EP2016/058156

§ 371 Date: Oct. 12, 2017

(30) Foreign Application Priority Data
Apr. 14, 2015 (EP) 15163527.3

(51) Int. Cl. C08F 2/34; C08F 2/01; C08F 6/00; C08F 6/02; C08L 23/00; C07F 5/06

(52) U.S. Cl. CPC C08F 2/34; C08F 2/01; C07F 5/066; C08F 6/02; C08L 23/00; C08F 6/001

(57) ABSTRACT

A method (100) is proposed for the preparation of a polyolefin from olefin monomers, wherein the olefin monomers are subjected to one or more polymerisation steps (13), in which a proportion of the olefin monomers are catalytically reacted to form the polyolefin, while the olefin monomers that are not reacted in the polymerisation step or steps (13) are at least partly transferred into one or more gaseous, monomer-containing purge streams (g, h), which additionally contain(s) one or more aluminium organic compounds, which comprise one or more co-catalysts used in the polymerisation step or steps (13) and/or one or more compounds formed from the co-catalyst(s). It is provided that, downstream of one or more olefin synthesis steps (21), the gaseous, monomer-containing purge stream or streams (g, h) are brought into contact with a crude gas mixture (p, r) formed using a product mixture from the olefin synthesis step or steps (21) and are subjected to a caustic wash (26) together with the crude gas mixture (p, r). The present invention also relates to a corresponding apparatus.

The invention relates to a method and an apparatus for the preparation of a polyolefin according to the pre-characterising clauses of the independent claims.

### PRIOR ART

Various methods are known for preparing polyolefins, for example polyethylene and polypropylene, and are described for example in the article “Polyolefins” in Ullmann's Encyclopedia of Industrial Chemistry, online edition, 15 Jun. 2000, DOI: 10.1002/14356007.a21_487, or the article by S. van der Wen, “Polypropylene and other Polyolefins: Polymerization and Characterization”, Studies in Polymer Science 7, Amsterdam: Elsevier Sciences 2007.

Frequently, in methods of this kind, non-polymerised monomers (such as ethylene and propylene) and also short-chain hydrocarbons (such as ethane and propane) formed in corresponding polymerisation reactions are purged from the polymer formed or from the polymerisation reactor by means of a gas stream and/or are drawn off in gaseous form from a separating container provided downstream. A gas mixture obtained in this way is hereinafter referred to as a “monomer-containing purge stream”.

When aluminium organic compounds (also known as aluminium organyls or organoaluminium compounds) are used as co-catalysts in polymerisation, in generally known manner, they may also go into a corresponding monomer-containing purge stream, in certain amounts. Therefore, in the prior art, monomer-containing purge streams of this kind are usually pre-treated with water or an aqueous medium in order to deactivate the aluminium organic compounds(s) contained therein. The monomer-containing purge stream is then utilised thermally. US 2011/0152476 A1 discloses a method in which washing with a mixture of sulphuric acid and light oil in a corresponding polymer plant is used for the elimination.

However, the thermal utilisation of monomer-containing purge streams means that substantial quantities of monomers which were produced beforehand, sometimes at high cost, are lost. It is therefore desirable in principle to recover not only the monomers but also other hydrocarbons from monomer-containing purge streams of this kind. This is made considerably more difficult, however, by the presence of the aluminium organic compounds.

The aluminium organic compounds under consideration here decompose when water is added to form aluminium hydroxide, inter alia. Aluminium hydroxide is soluble in strongly acid and strongly alkaline media but is virtually insoluble at a more neutral pH. A viscous, gel-like or solid mass may form here which can lead to deposits and blocking of parts of the apparatus. The introduction of a corresponding monomer-containing purge stream, which may lead to the formation of such a mass in certain parts of the apparatus, or a corresponding mass itself, into a petrochemical plant, particularly an olefin plant, is therefore to be avoided. Otherwise, there might be substantial adverse effects on the process and the operation of the plant, possibly leading to breakdown of the plant.

There is therefore a need for methods and apparatus in which it is possible to utilise and work up monomer-containing purge streams of the kind mentioned.

### DISCLOSURE OF THE INVENTION

This objective is achieved by a method and an apparatus for the production of a polyolefin having the features of the independent claims. Particular embodiments are recited in the dependent claims and in the description that follows.

### Advantages of the Invention

It has been recognised according to the invention that it is particularly advantageous to feed one or more gaseous monomer-containing purge streams containing one or more aluminium organic compounds into a caustic wash that is already provided. Caustic washes of this kind are conventionally used for processing crude gas mixtures which are formed for example by catalytic or thermal cracking processes and which may contain hydrogen sulphide and carbon dioxide, for example. Besides a cracking process, however, it is theoretically possible to use any other method for the recovery and subsequent working up of corresponding crude gas mixtures or a combination of such methods within the scope of the present invention, provided that a caustic wash is included at a suitable point in the course of the process. For example, there may be processes which are based, for example, on the (oxidative) dehydrogenation of alkanes or the oxidative coupling of methane. These processes are categorised hereinafter under the term “olefin synthesis steps”.

By a “crude gas mixture” is meant, in the terminology used herein, a gas mixture which is formed using a product mixture of one or more identical or different olefin synthesis steps occurring in parallel or sequentially. The “formation” of the crude gas mixture may also comprise, for example, process steps such as cooling, oil washing, compression and/or washing with water. If no such process steps are provided, the composition of the product mixture may also correspond to the composition of the crude gas mixture. The “formation” of the crude gas mixture may also encompass only the passing of the product mixture through suitable pipes and the provision thereof as a product mixture. In the formation of the crude gas mixture it is also possible for a plurality of product mixtures to be combined with one another. Product mixtures from synthesis steps other than the olefin synthesis steps mentioned above or streams from other parts of the apparatus may also be used. However, at least some of the crude gas mixture originates from one or more of the above-mentioned olefin synthesis steps. The formation of a crude gas mixture may also encompass the separation of a proportion of one or more product mixtures, but a crude gas mixture according to the definition as used here always contains components that are formed in the olefin synthesis step or steps. A “product mixture” is a mixture which typically comprises all the compounds obtained downstream of one or more olefin synthesis steps.

Hydrogen sulphide and carbon dioxide and other so-called sour gases are conventionally washed out of the above-mentioned crude gas mixtures by caustic washes of the kind described. In a caustic wash a corresponding crude gas mixture is introduced into an alkaline medium, for example a dilute aqueous sodium hydroxide solution. The sour gases present are thus dissolved in the alkaline medium. The medium charged with the acid gases is obtained as so-called spent lye. The spent lye can be regenerated by the elimination of the acid gases and re-used in the caustic wash. A caustic wash is usually carried out in a washing column, as explained in detail hereinafter.

The present invention proposes a method for the production of a polyolefin from olefin monomers, wherein the olefin monomers, for example ethylene and/or propylene, are subjected to one or more polymerisation steps in which a proportion of the olefin monomers are catalytically reacted to form the polyolefin, for example polyethylene and/or polypropylene, while the olefin monomers which are not reacted in the polymerisation step or steps are at least partly transferred into one or more gaseous, monomer-containing purge streams which additionally contain(s) one or more aluminium organic compounds, which may be one or more of the co-catalysts used in the polymerisation step or steps and/or one or more compounds formed from the co-catalyst(s). The problems that arise in a method of this kind according to the prior art have already been mentioned hereinbefore. As stated, it is normally difficult to use a corresponding monomer-containing purge stream in a further processing method, as the aluminium organic compounds may form a viscous, gel-like or even solid mass in a neutral aqueous solution.

It is therefore provided according to the invention that, downstream of one or more olefin synthesis steps, the gaseous, monomer-containing purge stream(s) are brought into contact with a crude gas mixture formed using a product mixture from the olefin synthesis step or steps, and are subjected to a caustic wash together with the crude gas mixture. The feeding of corresponding monomer-containing purge streams into a caustic wash has proved particularly beneficial, as it ensures a particularly efficient elimination thanks to the high dilution of the aluminium organic compound(s) on the one hand and the alkaline medium used in a comparatively large amount, on the other hand. Usually, a very large amount of lye is used, compared with the amount of aluminium organic compounds put in, with the result that the washing-out efficiency is exceptionally high.

The present invention thus makes it possible to wash out the aluminium organic compound(s) completely or virtually completely, in a defined manner, without the need for any additional process steps and/or essential additional operating means. One or more monomer-containing purge streams can easily and unproblematically be introduced into a caustic wash which is already present or is to be set up in any case, and have little effect on the volume streams or quantities of gas that are to be treated therein. An existing caustic wash therefore does not have to expanded in its capacity very much, if at all, for the purposes of the present invention. The present invention makes it possible to recover monomers easily and efficiently, as they can, in particular, be fed into an existing separation process downstream of the caustic wash. Since the aluminium organic compound(s) contained in the gaseous, monomer-containing purge stream or streams are washed out completely, or almost completely, in the caustic wash, there cannot be any blocking of components in the downstream section of a corresponding separation device. The present invention makes it possible to achieve a higher utilisation of materials over all, by completely avoiding the burning of raw materials (namely the olefin monomers specified).

Where it states, in the foregoing description or hereinafter, that the aluminium organic compound(s) is or are washed out “completely” or “almost completely”, this may encompass washing out the total amount of the aluminium organic compound(s) contained in the monomer-containing purge stream or streams, so that no more aluminium organic compound(s) can be detected in a purge stream from a caustic wash. However, traces of, for example, up to 10 mol.-ppm or ppm by weight, 1 mol.-ppm or ppm by weight or 0.1 mol.-ppm or ppm by weight may still remain if the aluminium organic compound(s) do not break down completely in contact with water. It is also possible to carry out the washing out until a defined residual content is obtained, for example a residual content of up to 100 mol.-ppm or ppm by weight, particularly up to 10 mol.-ppm or ppm by weight. The stream obtained is then referred to, in the terminology used herein, as being “depleted in or free from” the aluminium organic compound or compounds.

Downstream of one or more working-up steps to which a product mixture of the olefin synthesis steps is subjected, thereby forming the crude gas mixture, the gaseous, monomer-containing purge stream or streams may be combined with the crude gas mixture. If the crude gas mixture is dried, for example, and thus no longer contains any water with which the aluminium organic compound or compounds in the monomer-containing purge stream or streams can react, the gaseous, monomer-containing purge stream or streams may be combined with the crude gas mixture at any desired point downstream of the drying process. In this case, there may be no need for pipes. If such a drying process does not take place because the crude gas mixture is in any case coming into contact with an aqueous stream in the caustic wash and is thus taking up water, the gaseous, monomer-containing purge stream or streams are, by contrast, advantageously only brought into contact with the crude gas mixture in the caustic wash. In this way, the blocking of pipes upstream of the caustic wash can reliably be avoided, without the need for a costly drying process.

In such cases, the combining of the gaseous, monomer-containing purge stream or streams with the crude gas mixture therefore preferably takes place immediately before the caustic wash, particularly preferably directly in the caustic wash. By a combining that takes place “immediately before” the caustic wash is meant that a stream formed by the combining process is fed into the caustic wash without being subjected to influences that would affect its composition. Influences that might affect the composition of the stream formed by the combining process would be, for example, a longer dwell time of the stream formed by the combining process in a longer pipe system, during which aluminium hydroxide could be formed and deposited. However, other influences that might affect the composition are, in particular, the working-up steps mentioned, if they are used to separate components such as water, oily compounds or the like.

It is particularly advantageous if the working-up step or steps comprise a cooling and/or a wash with water. In particular, bringing the monomer-containing purge stream or streams into contact with the crude gas mixture downstream of a water wash ensures that the one or more aluminium organic compounds no longer come into contact with substantial amounts of water. Contact upstream of the water wash, and hence feeding into the olefin synthesis step or steps directly, or immediately afterwards, would be disadvantageous on the other hand, because in this way the aluminium organic compound or compounds present would also be fed into the water wash and could form aluminium hydroxide there. If the gaseous, monomer-containing purge stream or streams only come into contact with the crude gas mixture directly upstream of the caustic wash or in the latter, the formation of aluminium hydroxide that solidifies can be reliably prevented. Moreover, no solids can form in the caustic wash, as there are naturally strongly alkaline conditions there.

The caustic wash may be carried out in different process variants, within the scope of the present invention. However, as a rule, one or more washing columns are used, with the gaseous, monomer-containing purge stream or streams being brought into contact with the crude gas mixture in or upstream of the one or more washing columns.

The present invention can therefore be used in conventional equipment for carrying out caustic washes; no special adaptations are required. In particular, direct feeding into a washing column of a caustic wash has the particular advantage that no deposits that might be formed from any residual moisture present in the synthesis purge stream fed in could occur even in the feed pipes into the washing column. “Direct feeding” means that a pipe exclusively carrying the gaseous, monomer-containing purge stream or streams opens into an inner chamber of a corresponding washing column.

In known methods of forming corresponding gaseous, monomer-containing purge streams, a purging or stripping gas is used by means of which the polymer formed is flushed through or around (so-called purge). The purging gas may for example contain nitrogen, or consist of nitrogen. The present invention makes it possible to process even monomer-containing purge streams which contain nitrogen or other components of a purging gas without any additional working up (for example membrane processes for separating the expulsion gas from the monomers). Also, monomer-containing purge streams of this kind may be fed directly into the caustic wash. The purging gas is separated off in equipment provided downstream of the caustic wash.

The method may advantageously be carried out using one or more washing columns in the caustic wash, which have sections separated from one another by liquid barrier trays (so-called chimney trays); the number of sections can be selected according to the amount of substance to be washed out. The number of sections may be for example 2 to 5, particularly 2 to 3. Within the scope of the present invention, it is possible to feed the monomer-containing purge stream or streams into any desired column sections, depending on which area is convenient for the feeding and provides sufficient depletion.

In the bottom section of such washing columns, as a rule a coarse wash is carried out in which the great majority of the acid gas or gases is eliminated. After possible further washes in intermediate steps, a fine wash is carried out in the topmost section, in which the desired further depletion is achieved at a high caustic concentration, i.e. with little of the lye used up. Separate spent lyes are not usually formed as the hardly used spent lye from the fine wash is further enriched in the coarse wash and substantially used up therein.

Depending on the quantity of gases or crude gas mixtures to be processed, one or more washing columns may be used which are arranged in parallel or in series. The present invention may provide that the monomer-containing purge stream or streams is or are contacted with the crude gas mixture only in one washing column, or only in some of a plurality of washing columns. In this way, the aluminium organic compound or compounds, or compounds formed therefrom by the effect of the lye, are found only in the spent lye from the washing columns in question, so that only some of the washing lye has to be worked up, if indeed any working up at all is required. In other words, if a plurality of washing columns are used, the spent lye from at least one of these columns can be kept free from aluminium organic compound or compounds, or compounds formed therefrom.

The present invention is particularly suitable for use in methods in which the gaseous, monomer-containing purge stream or streams and the crude gas mixture are brought into contact, in the caustic wash, with a washing medium which contains sodium hydroxide in an amount of 0.5 to 20% by weight, particularly 1 to 12% by weight, especially 2 to 8% by weight, especially in an aqueous solution. With sodium hydroxide in aqeous solution, the aluminium from the aluminium organic compounds under consideration here is present in the form of sodium tetrahydroxoaluminate, which remains in solution under the alkaline process conditions prevailing, and can be eliminated with the spent lye by the normal processing method. As already mentioned, this elimination is assisted by the high dilution, as usually a very large amount of lye is used by comparison with the content of aluminium organic compounds. Separating aluminium from the spent lye, if required, because of regulations concerning maximum levels in purge water, is exceptionally easy and typically comprises neutralisation in the course of which aluminium hydroxide is precipitated and can therefore be separated off as a solid. The spent lye can therefore be freed from aluminium hydroxide without much expense.

The advantages of the invention are obtained particularly when the aluminium organic compound or compounds in the gaseous, monomer-containing purge stream or streams are present in an amount of up to 5% by weight, particularly up to 2.5% by weight, particularly up to 1.25% by weight, particularly up to 0.5% by weight, particularly up to 1.000 ppm by weight, particularly up to 500 ppm by weight. The one or more aluminium organic compounds may be present in an amount of more than 1, 10 or 100 ppm by weight. In this way, a particularly favourable dilution is obtained and hence a good elimination of the relevant compounds. The amounts specified are based on the proportion by mass of aluminium. In typical apparatus for the production of polyethylene, gaseous, monomer-containing purge streams are obtained with a flow volume of 10 to 300 kg/h, containing up to 1.2% by weight of triethylaluminium (TEA). Other apparatus operate for example with purge stream quantities of 50 to 100 kg/h with a content of 5 to 100 ppm by weight.

The present invention is generally suitable for all types of aluminium organic compounds which are used as polymerisation co-catalysts. The gaseous, monomer-containing purge stream or streams may contain the one or more aluminium organic compounds in the form of at least one aluminium alkyl, particularly triethylaluminium (TEA), and/or in the form of at least one methylaluminoxane and the derivatives thereof, and/or in the form of at least one halogenated aluminium compound with the empirical formulae AIR1R2X1 and/or AIR1X1X2, wherein R1 and R2 denote branched or unbranched C1- to C12-alkyl chains and X1 and X2 denote a halogen atom, and/or in the form of at least one further compound formed from the above-mentioned compounds. In particular, within the scope of the present invention, aluminium alkyls, especially triethylaluminium, and methylaluminoxanes are present with their derivatives and corresponding reaction products. As already mentioned, the invention is also suitable for monomer-containing purge streams which contain aluminium-containing secondary products that may be formed from the co-catalysts in the polymerisation step.

Within the scope of the present invention, a hydrocarbon-containing purge washing stream which is depleted in or free from the aluminium organic compound or compounds is obtained in the caustic wash. Hydrocarbons contained in the purge washing stream are fed into one or more separating steps, in which one or more olefin-rich fractions are obtained. As already mentioned, this is possible, without any limitations, by the use of the present invention, as the purge washing stream is depleted in or free from corresponding aluminium organic compounds.

The present invention makes it possible to achieve a fully integrated method in which the olefin monomers which are subjected to the polymerisation step or steps are prepared at least partially using the one or more olefin-rich fractions. However, the method is obviously also suitable for the external preparation of corresponding fractions or monomers. Corresponding monomers may also be stored intermediately, for example in pressure tanks, and kept ready for later use.

Advantageously, within the scope of the present invention, in the caustic wash a spent lye is obtained which contains at least the great majority of the one or more aluminium organic compounds or their reaction products with the lye from the monomer-containing purge stream or streams. This spent lye may be subjected to a method of working up or disposal known to the skilled man. In particular, a neutralisation, a steam treatment, spent lye oxidation, introduction into a (biological) sewage treatment apparatus or a suitable combination of such process steps may be carried out. For example, in the case of neutralisation, a sufficient level of dilution ensures that the above-mentioned aluminate or aluminium hydroxide is eliminated.

As mentioned above, the present invention is suitable for all olefin synthesis steps in which corresponding product mixtures are obtained, but particularly for thermal and/or catalytic cleavage process, such as steam cracking or Fluid Catalytic Cracking (FCC) and methods such as the (oxidative) dehydrogenation of alkanes or the oxidative coupling of methane. A hydrocarbon stream is fed into these olefin synthesis steps as the feed gas.

Methods and apparatus for steam cracking hydrocarbons are known and are described for example in the article “Ethylene” in Ullmann's Encyclopedia of Industrial Chemistry, online since 15 Apr. 2007, DOI: 10.1002/14356007.a10_045.pub2.

The present invention also includes an apparatus for the production of a polyolefin from olefin monomers. It has one or more polymerisation reactors which are set up so as to subject the olefin monomers to one or more polymerisation steps and thereby react some of the olefin monomers catalytically to form the polyolefin. Means are also provided which are designed to convert the olefin monomers that are not reacted in the polymerisation step or steps at least partly into one or more gaseous monomer-containing purge streams which additionally contain one or more aluminium organic compounds, which consist of one or more co-catalysts used in the polymerisation step or steps, and/or one or more compounds formed from the co-catalyst or co-catalysts.

According to the invention, means are provided which are designed to bring the gaseous, monomer-containing purge stream or streams,downstream of one or more olefin synthesis steps, into contact with a crude gas mixture formed using a product mixture from the olefin synthesis step or steps, and to subject it, together with the crude gas mixture, to a lye wash. The apparatus according to the invention benefits from the advantages outlined above, to which reference is therefore expressly made.

A corresponding apparatus advantageously comprises means which enable it to perform a process in the embodiments described above.

The invention is hereinafter explained in more detail by reference to the appended drawings, which show preferred embodiments of the invention.

### BRIEF DESCRIPTION OF THE DRAWINGS

FIG. 1 shows a method according to one embodiment of the invention in the form of a schematic flow diagram.

FIG. 2 shows details of the method illustrated in FIG. 1 in the form of a schematic process flow diagram.

In the Figures, corresponding elements have been given identical reference numerals and, in the interests of clarity, the description thereof has not been repeated. In all the Figures, method steps and apparatus are indicated by numerals, whereas streams of matter are indicated by lower-case or upper-case letters.

### EMBODIMENTS OF THE INVENTION

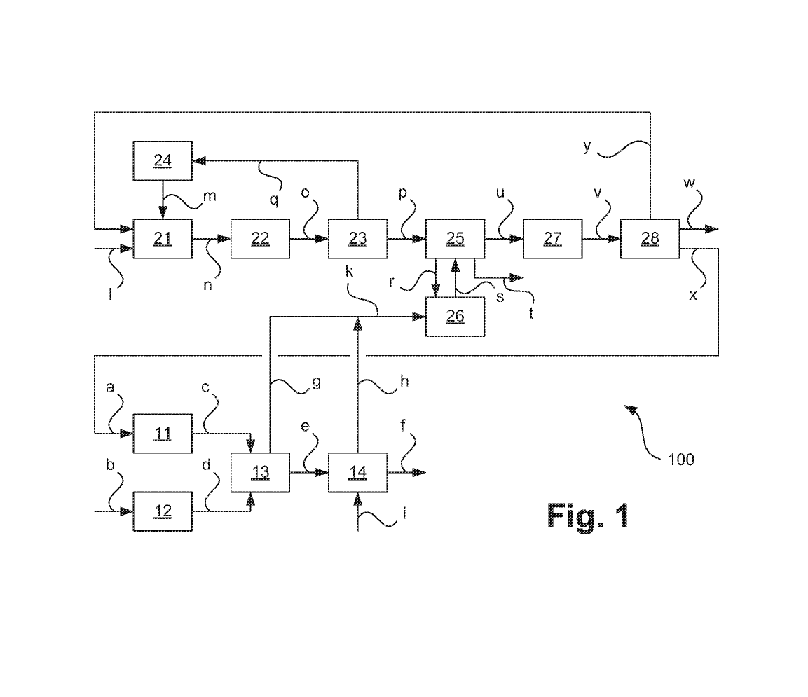

FIG. 1 shows a method according to one embodiment of the invention in the form of a schematic flow diagram. The method is generally designated 100. The method 100 comprises steps 11 to 14 for preparing a polyolefin and steps 21 to 28 for preparing olefins.

Method steps 21 to 28 for preparing the olefins are typical for a steam cracking process as described above. As mentioned previously, the method according to the invention is suitable for all olefin syntheses in which a corresponding product mixture or a crude gas mixture obtained from the product mixture is subjected to a caustic wash.

In the embodiment of the method 100 illustrated in FIG. 1 a stream a, which contains olefin monomers such as ethylene and/or propylene, is subjected to a working up and/or treatment step 11. In the working up or treatment step 11, the stream a, for example, can be brought to a suitable pressure, purified and/or temperature-controlled. The working up or treatment step 11 may also be omitted.

A stream thus obtained, now designated c, is fed into one or more polymerisation steps 13 in a suitable reactor. In addition, a stream d which may for example contain additives and/or excipients required for the polymerisation, for example one or more aluminium organic compounds which are used as co-catalysts in the polymerisation step or steps 13, is subjected to the polymerisation step or steps 13. Instead of an individual stream d, a plurality of corresponding streams may be used which may contain different additives and/or excipients. The stream d (or plurality of corresponding streams) may be subjected to a corresponding working up or treatment step 12, corresponding to the working up or treatment step 11, and be formed from a feed stream b (or a plurality of feed streams). The working up or treatment step 12 may also be omitted.

In the polymerisation step or steps 13, depending on the polymerisation yield, some of the olefin monomers supplied in the form of the stream c are reacted to form a polyolefin. The method is equally suitable for the production of homo- and heteropolymers. In the polymerisation step or steps 13 a stream e is obtained which contains the corresponding polyolefin, for example in liquid form and/or in the form of a granulate.

The stream e is fed into a degassing or gas purging step 14 where it is substantially or completely freed from any monomers and other short-chained hydrocarbons that are still present. Corresponding compounds may also be obtained from polymerisation step 13, as illustrated by the stream g, by being drawn off from a reactor, for example. In the degassing step 14, or as early as the polymerisation step 13, a purge gas stream i, such as nitrogen, for example, may be used, to flush around or through the polyolefin. In this way, the olefin monomers, as well as other compounds contained in the stream e, such as short-chain paraffins which are formed in the polymerisation step or steps 13, are transferred into a gaseous stream g and/or h. Both the stream g and the stream h, which are referred to here as “monomer-containing purge streams”, contain amounts of a co-catalyst used in the polymerisation step or steps 13, in addition to the monomers and optionally short-chained hydrocarbons as well as the purge gas of stream i, such as nitrogen, as mentioned above. They are therefore not suitable for feeding directly into process steps in which water is used at a neutral pH, since, as previously stated, this can be expected to result in the formation of gel or solids. The monomer-containing purge stream or streams g and/or h may also be combined to form a combined stream k and are fed into a caustic wash 26 in the embodiment shown.

In process step or steps 21 to 28 for producing olefins, a stream I, typically together with at least one recycled stream y, is subjected to one or more olefin synthesis steps 21. In the olefin synthesis step or steps 21, which are carried out in one or more cracking furnaces in the embodiment shown, a vapour stream m is also used. As already mentioned, the method according to the invention is also suitable for other olefin syntheses in which an olefin synthesis step 21 is carried out catalytically and, if desired, no vapour stream m is used. In the olefin synthesis step or steps a product mixture is obtained, as illustrated by the stream n.

The product mixture n, a so-called cracking gas in the case of a steam cracking process, is fed into one or more working-up steps 22, 23. For example, the stream n is first cooled in a cooling step 22, for example by means of a linear cooler and/or using so-called quenching oil, thus producing a stream o. A stream of higher-molecular compounds may be separated off as early as the cooling step 22, although this is not illustrated separately. The stream o can then be subjected to a water wash 23, for example, by passing the stream o in countercurrent to a water stream. The stream o is further cooled by means of this stream of water and higher molecular compounds in the stream o such as pyrolysis gasoline and other compounds, for example, can be washed out. In the water wash 23, a stream of water q may be obtained which is fed into a steam generator 24. The above-mentioned vapour stream m is obtained in the steam generator 24.

A stream p obtained in the water wash can then be subjected to a compression step 25. In the terminology used here, as already mentioned, streams formed in any way from a product mixture of the stream n, such as the stream p, are referred to as “crude gas mixtures”. The compression step 25 can be carried out for example using a multi-stage compressor into which fluid streams can be fed and removed at different pressure stages. For details, reference may be made to the above-mentioned article “Ethylene” in Ullmann's Encyclopedia of Industrial Chemistry. For example, a stream r may be taken from the compression step 25 at a suitable pressure; in the terminology used in this application this is a crude gas mixture from the olefin synthesis step or steps 21.

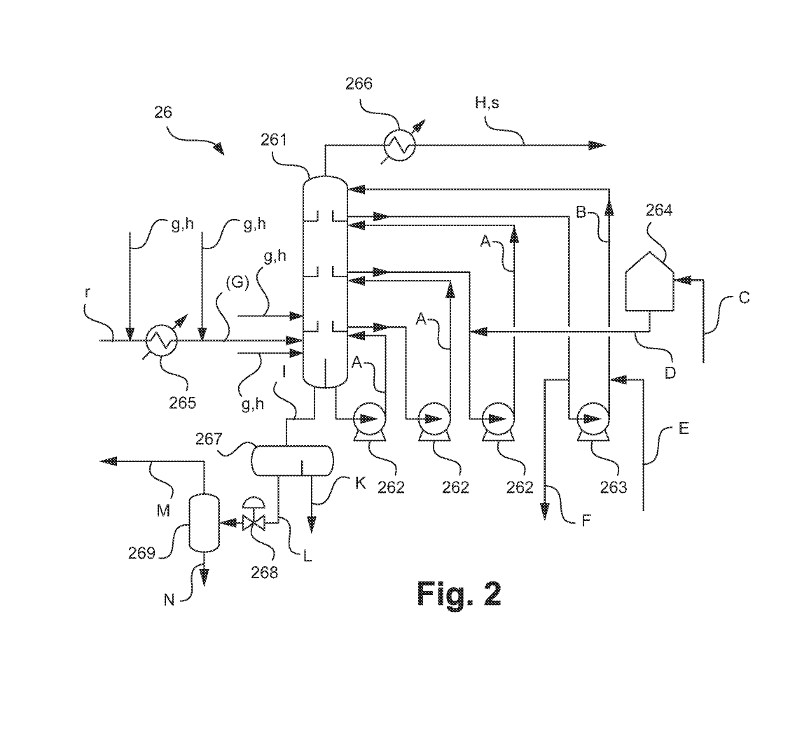

The stream r is subjected to a caustic wash 26, which is illustrated in detail in FIG. 2. The caustic wash serves to wash so-called acid gases, particularly hydrogen sulphide and carbon dioxide, out of the fluid of the stream r. According to the embodiment of the invention shown in FIG. 1, the monomer-containing purge streams g, h or a combined stream formed therefrom are simultaneously fed into the caustic wash 26, as is also shown in detail in FIG. 2. According to the embodiment of the invention shown here, the aluminium organic compound or compounds contained in the monomer-containing purge stream or streams g, h, or in the combined stream k, is or are also washed out in the caustic wash in addition to the above-mentioned acid gases.

A stream, designated s in FIG. 1, processed in this manner using the caustic wash is fed into the compression step 25 or into a compressor used in the compression step 25, at a suitable pressure stage and is further compressed therein. In the compression step 25, in addition to a stream u, which is fed into a drying step 27, for example, a stream t (condensate) of higher molecular compounds may also be obtained. A stream obtained by means of the drying step 27, now designated v, can be sent into a separation means 28 in which the compounds contained in the stream v are converted into different fractions or corresponding streams w, x and/or y. The separation 28 may be carried out in any desired manner. At least some of the fractions or streams formed in the separation 28 may be recycled back into the olefin synthesis step or steps 21, as illustrated here by stream y. In particular, these are saturated hydrocarbons, for example, which are not suitable for polymerisation. Further fractions, such as aromatic compounds, may also be removed from the process as required, as illustrated here by stream w.

A stream, here designated x, contains ethylene and/or propylene, for example, and can be subjected, as feed stream a, to the working up and/or treatment steps 11 upstream of the polymerisation step or steps 13. It will be understood that the streams x and a may also be decoupled, so that, for example, monomer obtained in the separation means 28 can be stored intermediately, or step a need not consist exclulsively, or at all, of the compounds contained in the stream x. Also, the stream x may also be only partially converted into a feed stream a, in which case a partial stream of x is utilised in some other way.

As already mentioned, FIG. 2 shows details of the caustic wash 26. The central component of an apparatus used in the caustic wash 26 is a washing column 261 which is illustrated here with four sections. The sections are not separately designated. The sections are separated from one another by means of liquid barrier trays, which are not separately designated either. The lowest section of the washing column 261 is usually provided with a partition wall which makes it possible to separate the spent lye from the washing lye that is to be recycled. The spent lye and washing lye are comparable in their compositions, but the partition wall makes it possible to separate off a floating organic phase and preferably convey it into the spent lye.

In the washing column 261. a basic washing medium is used which is introduced, by means of pumps 262 in the form of the streams designated A, into an upper region of the three lower sections of the washing column 261 and is drawn off above the respective liquid barrier tray. In the topmost section of the washing column 261, a water stream B may be used, which is also supplied by means of a suitable pump 263. A fresh water stream is illustrated in the form of the stream E, while a purge water stream is illustrated in the form of the stream F. By suitable adjustment of the streams E and F it can be ensured that the stream B always has an adequate washing capacity. Fresh washing medium can be supplied in the form of the streams C and D and can be stored intermediately in a storage tank 264.

As shown in FIG. 2, the crude gas mixture designated r in FIG. 1 which is partially compressed in the compression step 25 is temperature-controlled by means of a heat exchanger 265. Upstream and/or downstream of the heat exchanger 265 the stream r may be combined with the monomer-containing purge stream or streams g, h or a corresponding combined stream k, thereby forming a stream which is designated G here. It should be understood that all the streams designated g, h in FIG. 2 each illustrate alternative feed points for gaseous, monomer-containing purge streams. Thus, one or more monomer-containing purge streams can also be fed directly into the washing column 261, for example below the feed point for the stream r or the stream G. Depending on the washing out required, they can also be fed into a column section located above.

As a result of the caustic wash by means of the streams A and the final water wash by means of the stream B, a stream H can be drawn off at the top of the washing column 261 which is free from, or substantially free from unwanted compounds such as the above-mentioned so-called sour gases, but also of the aluminium organic compound or compounds. A corresponding stream H can be temperature-controlled by means of a heat exchanger 266 and further treated in the form of the stream s, as explained in connection with FIG. 1.

A purge stream I, which may also contain oil-like compounds, inter alia, can be removed from the sump of the lowest section of the washing column 261. These can be discharged in the form of a stream K using an oil separator 267. The remaining stream, here designated L, can be released through a relief valve 268 and transferred into a degassing container 269. In the degassing container 269, volatile compounds can be converted into the gaseous phase and drawn off in the form of the stream M. Degassed spent lye can be discharged in the form of the stream N and is typically sent for disposal.

1. Method (100) for producing a polyolefin from olefin monomers, wherein the olefin monomers are subjected to one or more polymerisation steps (13), in which a proportion of the olefin monomers are catalytically reacted to form the polyolefin, while the olefin monomers that are not reacted in the polymerisation step or steps (13) are at least partly transferred into one or more gaseous, monomer-containing purge streams (g, h), which additionally contain(s) one or more aluminium organic compounds, which comprise one or more co-catalysts used in the polymerisation step or steps (13) and/or one or more compounds formed from the co-catalyst(s), characterised in that, downstream of one or more olefin synthesis steps (21), the gaseous, monomer-containing purge stream or streams (g, h) are brought into contact with a crude gas mixture (p, r) formed using a product mixture from the olefin synthesis step or steps (21) and are subjected to a caustic wash (26) together with the crude gas mixture (p, r).

2. Method (100) according to claim 1, wherein the gaseous, monomer-containing purge stream or streams (g, h) is or are combined with the crude gas mixture (r), downstream of one or more working-up steps (22, 23) to which the product mixture of the olefin synthesis step or steps (21) is or are subjected during the formation of the crude gas mixture (p, r).

3. Method (100) according to claim 2, wherein the working-up step or steps comprise a cooling (22) and/or a water wash (23).

4. Method (100) according to one of the preceding claims, wherein one or more washing columns (261) are used in the caustic wash (26), and wherein the gaseous, monomer-containing purge stream or streams (g, h) are brought into contact with the crude gas mixture (p, r) in or upstream of the one or more washing columns (261).

5. Method (100) according to claim 4, wherein one or more washing columns (261) are used which comprise sections separated from one another by liquid barrier trays, the number of sections being two to five, more particularly two to three.

6. Method (100) according to claim 4 or 5, wherein a plurality of washing columns (261) are used which are connected in parallel and/or in series.

7. Method (100) according to one of the preceding claims, wherein the gaseous, monomer-containing purge stream or streams (g, h) and the crude gas mixture (p, r) are brought into contact with an alkaline washing medium in the caustic wash (26), the alkaline washing medium containing sodium hydroxide in an amount of 0.5 to 20% by weight, particularly 1 to 10% by weight, particularly 1 to 6% by weight.

8. Method (100) according to one of the preceding claims, wherein the one or more aluminium organic compounds are present in the gaseous, monomer-containing purge stream or streams (g, h) in an amount of up to 5% by weight, particularly up to 2.5% by weight, particularly up to 1.25% by weight, particularly up to 0.5% by weight, particularly up to 1000 ppm by weight, based on the aluminium present.

9. Method (100) according to one of the preceding claims, wherein the gaseous, monomer-containing purge stream or streams (g, h) contain the one or more aluminium organic compounds in the form of at least one aluminium alkyl and/or in the form of at least one methylaluminoxane and/or in the form of at least one halogenated aluminium compound with the empirical formulae AIR1R2X1 and/or AIR1X1X2, wherein R1 and R2 denote branched or unbranched C1- to C12-alkyl chains and X1 and X2 denote a halogen atom, particularly triethylaluminium, and/or in the form of at least one compound formed from the above-mentioned compounds.

10. Method (100) according to one of the preceding claims, wherein a hydrocarbon-containing purge washing stream (u) which is depleted in or free from the aluminium organic compound or compounds is obtained in the caustic wash (26), and wherein hydrocarbons contained in the purge washing stream (u) are fed into one or more separating steps (26), in which one or more olefin-rich fractions (x) are obtained.

11. Method (100) according to claim 10, wherein the olefin monomers which are subjected to the polymerisation step or steps (13) are prepared at least partially using the one or more olefin-rich fractions (x).

12. Method (100) according to one of the preceding claims, wherein the olefin synthesis step or steps (21) encompass at least one thermal and/or catalytic cleavage step and/or at least one step for the dehydrogenation of alkanes and/or at least one step for the oxidative coupling of methane.

13. Apparatus for the production of a polyolefin from olefin monomers having one or more polymerisation reactors which are set up so as to subject the olefin monomers to one or more polymerisation steps (13) and thereby react some of the olefin monomers catalytically to form the polyolefin, and having means which are designed to transfer the olefin monomers that are not reacted in the polymerisation step or steps (13) at least partly into one or more gaseous monomer-containing purge streams (g, h) which additionally contain one or more aluminium organic compounds, which consist of one or more co-catalysts used in the polymerisation step or steps (13), and/or one or more compounds formed from the co-catalyst or co-catalysts, characterised by means which are designed to bring the gaseous, monomer-containing purge stream or streams (g, h),downstream of one or more olefin synthesis steps (21), into contact with a crude gas mixture (p, r) formed using a product mixture from the olefin synthesis step or steps (21), and to subject it, together with the crude gas mixture (p, r), to a caustic wash (26).
